(19) United States
(12) Patent Application Publication
(10) Pub. No.: US 2024/0234828 A9
(43) Pub. Date: Jul. 11, 2024

(54) LITHIUM SECONDARY BATTERY AND MANUFACTURING METHOD FOR LITHIUM SECONDARY BATTERY

(71) Applicant: SK ON CO., LTD., Seoul (KR)

(72) Inventor: Young Im KWON, Daejeon (KR)

(21) Appl. No.: 18/492,376

(22) Filed: Oct. 23, 2023

(30) Foreign Application Priority Data
Oct. 24, 2022 (KR) 10-2022-0137470

(51) Int. Cl. H01M 10/0585; H01M 4/66; H01M 10/0525; H01M 50/105; H01M 50/536

(52) U.S. Cl. CPC H01M 10/0585; H01M 4/661; H01M 10/0525; H01M 50/105; H01M 50/536

(57) ABSTRACT

A lithium secondary battery based on one embodiment of the disclosed technology comprises an exterior member; and electrode cells disposed within the exterior member and each comprising a cathode, an anode, and a separator disposed between the cathode and the anode. Cathode tabs are disposed on a first side of the cathode. Anode tabs are disposed on a second side of the anode that is different from the first side. The cathode tabs and the anode tabs are formed asymmetrically on different sides.

### CROSS-REFERENCE TO RELATED PATENT APPLICATION

This patent document claims the priority and benefits of Korean patent application number 10-2022-0137470 filed on Oct. 24, 2022, the entire disclosure of which is incorporated herein by reference.

### TECHNICAL FIELD

The technology and implementations disclosed in this patent document generally relate to a lithium secondary battery and a manufacturing method for lithium secondary battery.

### BACKGROUND

With the recent development in the electronics, communications, and space industries, the demand for lithium secondary batteries as an energy power source is drastically increasing. In particular, the electric vehicle market is growing swiftly as a result of eco-friendly policies in major countries, and research and development on lithium secondary batteries are being actively conducted worldwide.

### SUMMARY

An embodiment of the disclosed technology is to provide a lithium secondary battery and a manufacturing method of lithium secondary battery in which a tab formation process can be performed carefully so that risks that may occur during the process are prevented.

A lithium secondary battery based on an embodiment of the disclosed technology may comprise an exterior member; and electrode cells disposed within the exterior member and each comprising a cathode, an anode, and a separator disposed between the cathode and the anode. Cathode tabs may be disposed on a first side of the cathode. Anode tabs may be disposed on a second side of the anode that is different from the first side. The cathode tabs and the anode tabs may be formed asymmetrically on different sides.

In an embodiment, the lithium secondary battery may further comprise a cathode lead that is electrically connected to the cathode through the cathode tabs; and an anode lead that is electrically connected to the anode through the anode tabs. The second side may be an opposite side of the first side.

In an embodiment, the number of the anode tabs may be greater than the number of the cathode tabs.

In an embodiment, the cathode may comprise a cathode current collector and a cathode active material layer on the cathode current collector. The anode may comprise an anode current collector and an anode active material layer on the anode current collector. The thickness of the anode current collector may be thinner than the thickness of the cathode current collector.

In an embodiment, the anode current collector may comprise copper. The cathode current collector may comprise aluminum.

In an embodiment, at least one of the cathode tabs may be disposed adjacent to a first edge of the first side, and at least one other of the cathode tabs may be disposed adjacent to a second edge of the first side. At least one of the anode tabs may be disposed adjacent to the first edge of the second side, and at least one other of the anode tabs may be disposed adjacent to the second edge of the second side.

In an embodiment, at least one of the anode tabs may be disposed in a central portion of the second side. The cathode tabs may not be disposed in a central portion of the first side.

In an embodiment, the electrode cells may have a stack-type structure.

A manufacturing method for lithium secondary battery based on an embodiment of the disclosed technology may comprise laminating electrode cells; forming electrode tabs; and forming electrode leads. The forming electrode tabs may comprise forming cathode tabs on first sides of cathodes of the electrode cells; and forming anode tabs on second sides of anodes of the electrode cells that are different from the first sides. The cathode tabs and the anode tabs may be formed asymmetrically on different sides.

In an embodiment, the number of the anode tabs may be greater than the number of the cathode tabs.

In an embodiment, the cathodes may each comprise a cathode current collector and a cathode active material layer on the cathode current collector. The anodes may each comprise an anode current collector and an anode active material layer on the anode current collector. The thickness of the anode current collector may be thinner than the thickness of the cathode current collector.

In an embodiment, the forming electrode tabs may comprise performing a welding process for forming the cathode tabs and the anode tabs.

In one embodiment of the disclosed technology, a lithium secondary battery and a manufacturing method for lithium secondary battery may be provided in which a tab formation process can be performed carefully so that risks that may occur during the process are prevented.

### BRIEF DESCRIPTION OF THE DRAWINGS

FIG. 1 is a schematic cross-sectional diagram of a lithium secondary battery based on an embodiment.

FIG. 2 is a schematic perspective diagram of a lithium secondary battery based on an embodiment.

FIG. 3 is a schematic plan diagram of a lithium secondary battery based on an embodiment.

FIG. 4 is a schematic diagram showing an arrangement structure of cathode tabs based on an embodiment.

FIG. 5 is a schematic diagram showing an arrangement structure of anode tabs based on an embodiment.

FIG. 6 is a schematic flowchart of a manufacturing method for lithium secondary battery based on an embodiment.

### DETAILED DESCRIPTION

Section headings are used in the present document only for ease of understanding and do not limit scope of the embodiments to the section in which they are described.

Structural or functional descriptions of embodiments disclosed in the present specification or application are merely illustrated for the purpose of describing embodiments based on the technical principle of the disclosed technology. In addition, embodiments based on the technical principle of the disclosed technology may be implemented in various forms other than the embodiments disclosed in the present specification or application. In addition, the technical principle of the disclosed technology is not to be construed as being limited to the embodiments described in this specification or application.

A lithium secondary battery may include an electrode cell that includes a cathode, an anode, and a separator disposed therebetween. Each of the cathode and the anode may include an active material so that lithium ions are inserted to and extracted from the active material.

In order for a battery to secure a sufficient energy density, a sufficient number of electrode cells need to be laminated. However, when an excessive number of electrode cells are laminated, it may be difficult to smoothly perform a welding process for forming tabs for electrically connecting electrode cells to the outside. To address this issue, the disclosed technology can be implemented in some embodiments to provide a method for efficiently performing a welding process for forming tabs while sufficiently securing energy density in a battery.

Hereinafter, a lithium secondary battery and a manufacturing method for lithium secondary battery based on embodiments are described with reference to the accompanying drawings.

1. Lithium Secondary Battery

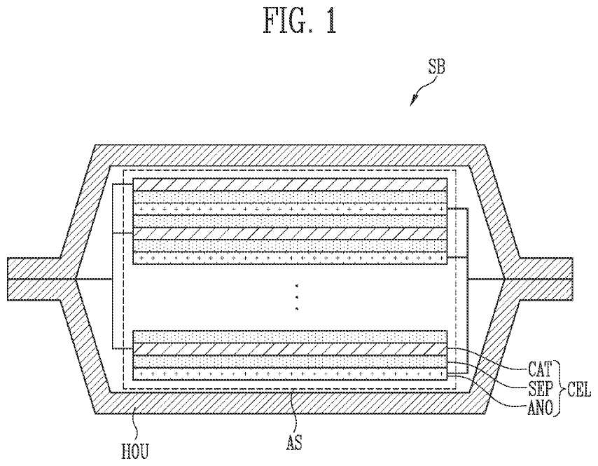

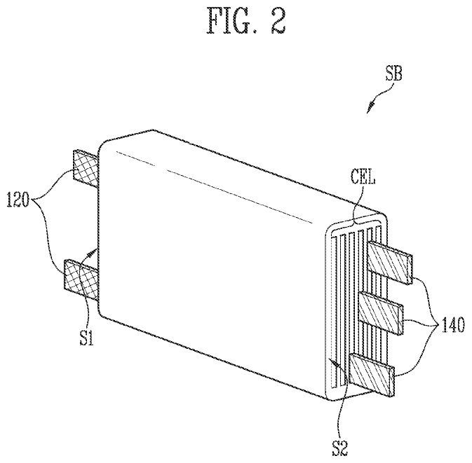

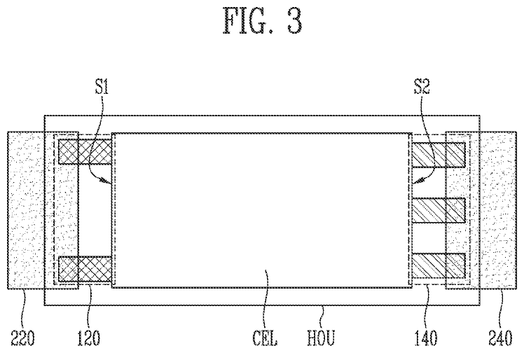

FIG. 1 is a schematic cross-sectional diagram of a lithium secondary battery based on an embodiment. FIG. 2 is a schematic perspective diagram of a lithium secondary battery based on an embodiment. FIG. 3 is a schematic plan diagram of a lithium secondary battery based on an embodiment.

Referring to FIGS. 1 to 3, a lithium secondary battery SB may comprise an exterior member HOU, a cathode CAT, an anode ANO, and a separator SEP. In an embodiment, a lithium secondary battery SB may further comprise a cathode tab 120, an anode tab 140, a cathode lead 220, and an anode lead 240.

An exterior member HOU may be provided to surround or enclose internal components of a lithium secondary battery SB to protect internal components from external influences. An exterior member HOU may be a housing. An exterior member HOU may be implemented in various configurations for different applications, including one of a pouch type structure, a can type structure, and a prismatic type structure, and is not limited to a specific fixed configuration.

Each of a cathode CAT and an anode ANO may comprises a current collector forming a plate and an active material layer disposed on a current collector. For example, a cathode CAT may comprise a cathode current collector and a cathode active material layer disposed on a cathode collector, and an anode ANO may comprise an anode current collector and an anode active material layer disposed on an anode current collector.

A current collector may comprise a conductive material within a range that does not cause a chemical reaction in a lithium secondary battery SB. For example, a current collector may comprise any one of stainless steel, nickel (Ni), aluminum (Al), titanium (Ti), copper (Cu), and an alloy thereof, and may be provided in various forms such as film, sheet, and foil. In an embodiment, a cathode may comprise aluminum, and an anode collector may comprise copper. In addition, the thickness of a cathode current collector may be thicker than the thickness of an anode current collector.

An active material layer includes an active material. For example, a cathode active material layer may include a cathode active material, and an anode active material layer may include an anode active material.

A cathode active material may include an active material that allows lithium ions to be inserted to and extracted from the active material. In some implementations, a cathode active material may be a lithium metal oxide. For example, a cathode active material may include at least one of a lithium manganese oxide, a lithium nickel oxide, a lithium cobalt oxide, a lithium nickel manganese oxide, a lithium nickel cobalt manganese oxide, a lithium nickel cobalt aluminum oxide, a lithium iron phosphate-based compound, a lithium manganese phosphate-based compound, a lithium cobalt phosphate-based compound, or a lithium vanadium phosphate-based compound. However, the disclosed technology is not necessarily limited to the examples described above.

An anode active material may include an active material that allows lithium ions to be inserted to and extracted from the active material. For example, an anode active material may include at least one of carbon-based materials such as crystalline carbon, amorphous carbon, carbon composite, and carbon fiber, a lithium alloy, silicon (Si), or tin (Sn). In an embodiment, an anode active material may be natural graphite or artificial graphite, but is not limited to a specific example.

A cathode CAT and an anode ANO may each further comprise a binder and a conductive material.

A binder may improve mechanical stability of the cathode CAT and the anode ANO by holding a current collector and an active material layer together. In an embodiment, a binder may be an organic binder or an aqueous binder, and may be used together with a thickener such as carboxymethyl cellulose (CMC). In an embodiment, an organic binder may be one of vinylidene fluoride-hexafluoropropylene copolymer (PVDF-co-HFP), polyvinylidene fluoride (PVDF), polyacrylonitrile, and polymethylmethacrylate, and an aqueous binder may be styrene-butadiene rubber (SBR), but the disclosed technology is not necessarily limited thereto.

A conductive material may improve electrical conductivity of a lithium secondary battery SB. A conductive material may comprise a metal-based material. In an embodiment, a conductive material may comprise any type of carbon-based conductive material. For example, a conductive material may comprise any one of graphite, carbon black, graphene, and carbon nanotubes. In an implementation, a conductive material may comprise carbon nanotubes.

A separator SEP may be disposed between a cathode CAT and an anode ANO. A separator SEP is configured to prevent an electrical short circuit between a cathode CAT and an anode ANO and to generate a flow of ions.

A separator SEP may comprise a porous polymer film or a porous nonwoven fabric. Here, a porous polymer film may be configured as a single layer or a multi-layer comprising a polyolefin polymer such as an ethylene polymer, a propylene polymer, an ethylene/butene copolymer, an ethylene/hexene copolymer, and an ethylene/methacrylate copolymer. A porous nonwoven fabric may comprise glass fibers of a high melting point and polyethylene terephthalate fibers. However, the disclosed technology is not limited thereto, and based on an embodiment, a separator may be a highly heat-resistance separator (e.g., ceramic coated separator (CCS)) comprising ceramic.

In an embodiment, an electrode cell CEL comprising a cathode CAT, an anode ANO, and a separator SEP may be provided. A plurality of electrode cells CEL may be provided to be wound, laminated, or folded, and thus an electrode assembly AS may be provided.

In an embodiment, a lithium secondary battery SB may include an electrode assembly AS together with an electrolyte. In an embodiment, a lithium secondary battery SB may be any one of a cylindrical type using a can, a prismatic type, a pouch type, and a coin type, but is not limited thereto.

An electrolyte may be a non-aqueous electrolyte. An electrolyte may comprise a lithium salt and an organic solvent.

An organic solvent may comprise one of propylene carbonate (PC), ethylene carbonate (EC), diethyl carbonate (DEC), dimethyl carbonate (DMC), ethylmethyl carbonate (EMC), methylpropyl carbonate (MPC), dipropyl carbonate (DPC), vinylene carbonate (VC), dimethyl sulfoxide, acetonitrile, dimethoxyethane, diethoxyethane, sulfolane, gamma-butyrolactone, propylene sulfide, and tetrahydrofuran.

In some implementations, a cathode CAT may be connected to a cathode tab 120 and may be electrically connected to a cathode lead 220 made of a conductive material through a cathode tab 120. In an embodiment, an anode ANO may be connected to an anode tab 140 and may be electrically connected to an anode lead 240 made of a conductive material through an anode tab 140.

A cathode lead 220 and an anode lead 240 that are electrically connected to a cathode tab 120 and an anode tab 140 may function as an electrode interface electrically connecting a lithium secondary battery SB and an external device to each other.

A cathode tab 120 and an anode tab 140 may be disposed on different sides. For example, a cathode tab 120 and a cathode lead 220 may be disposed on a first side S1 of electrode cells CEL (or a cathode CAT and an anode ANO). An anode tab 140 and an anode lead 240 may be disposed on a second side S2 of electrode cells CEL (or a cathode CAT and an anode ANO). In an embodiment, a first side S1 and a second side S2 may mean different sides. For example, a second side S2 may be an opposite side of a first side S1.

A cathode tab 120 may be formed by combining first conductive lines extending from each of a plurality of cathodes CAT. A single cathode tab 120 may be electrically connected to a plurality of cathodes CAT. For example, first conductive lines for forming a cathode tab 120 may be bonded by a bonding method such as general resistance welding, ultrasonic welding, laser welding, and rivet, and accordingly, a cathode tab 120 electrically connected to a plurality of cathodes CAT may be manufactured.

An anode tab 140 may be formed by combining second conductive lines extending from each of the plurality of anodes ANO. A single anode tab 140 may be electrically connected to a plurality of anodes ANO. For example, second conductive lines for forming an anode tab 140 may be bonded by a bonding method such as general resistance welding, ultrasonic welding, laser welding, and rivet, and accordingly, an anode tab 140 electrically connected to a plurality of anodes ANO may be manufactured.

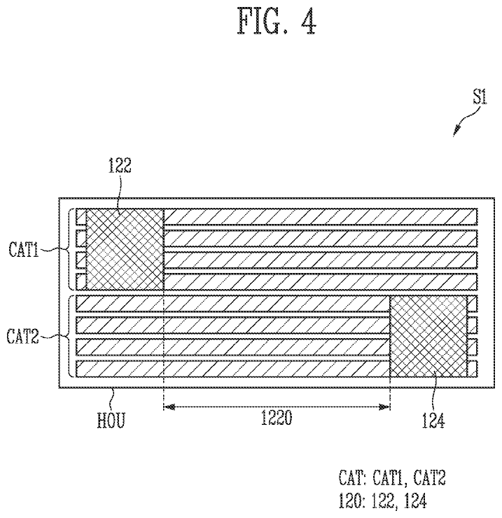

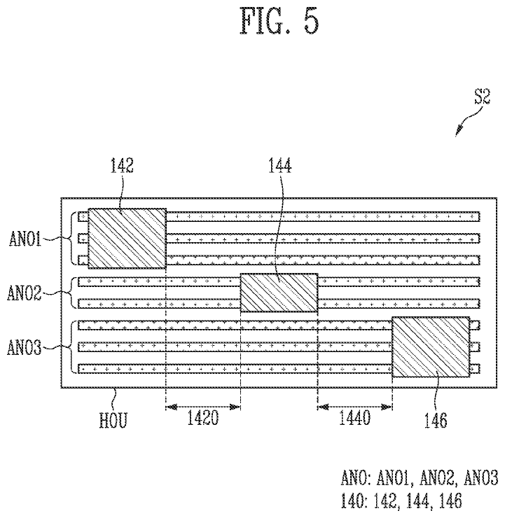

Hereinafter, structures of a cathode tab 120 and an anode tab 140 will be described in more detail with reference to FIGS. 4 and 5. FIG. 4 is a schematic diagram showing an arrangement structure of cathode tabs based on an embodiment. FIG. 5 is a schematic diagram showing an arrangement structure of anode tabs based on an embodiment. FIG. 4 may be a diagram showing a first side S1 of electrode cells CEL. FIG. 5 may be a diagram showing a second side S2 of electrode cells CEL.

In some implementations, a plurality of cathode tabs 120 may electrically connect conductive lines extending from each of a plurality of cathodes CAT (e.g., a cathode current collector). For example, a cathode CAT may comprise first cathodes CAT1 and second cathodes CAT2, and an cathode tab 120 may comprise a first cathode tab 122 and a second cathode tab 124. In some implementations, a first cathode tab 122 may be formed by bonding conductive lines extending from first cathodes CAT1. A second cathode tab 124 may be formed by bonding conductive lines extending from second cathodes CAT2.

In some implementations, a plurality of anode tabs 140 may electrically connect conductive lines extending from each of a plurality of anodes ANO (e.g., an anode current collector). For example, anodes ANO may comprise first anodes ANO1, second anodes ANO2, and third anodes ANO3, and an anode tab 140 may comprise a first anode tab 142, a second anode tab 144, and a third anode tab 146. At this time, a first anode tab 142 may be formed by bonding conductive lines extending from first anodes ANO1. A second anode tab 144 may be formed by bonding conductive lines extending from second anodes ANO2. A third anode tab 146 may be formed by bonding conductive lines extending from third anodes ANO3.

In an embodiment, a plurality of cathode tabs 120 and a plurality anode tabs 140 may be provided to reduce the risks involved in a welding process for forming a cathode tab 120 and an anode tab 140. For example, the risks involved in a welding process may include an excessive welding, an insufficient welding, or a conductive path disconnection. In an embodiment, sequentially laminated cathodes CAT or anodes ANO may be separated into several sets, and each cathode CAT or each anode ANO of each set may be connected to a separate cathode tab 120 or an anode tab 140. Accordingly, the disclosed technology can be implemented in some embodiments to reduce or minimize the risks described above that may occur when an excessively large number of cathodes CAT or anodes ANO are connected to a single cathode tab 120 or anode tab 140.

In particular, an electrode assembly AS based on an embodiment may have a stack-type structure formed by sequentially laminating electrode cells CEL. When electrode cells CEL have a stack-type structure, there is an advantage that energy density of a lithium secondary battery SB can be sufficiently secured.

In various other designs, when electrode cells CEL are manufactured to have a stack-type structure, due to limitations in a welding process for forming a cathode tab 120 and an anode tab 140, it may be difficult to laminate a sufficient number of electrode cells CEL. However, in the disclosed stack-type structure design as described above, of the cathode tabs 120 and anode tabs 140 are disposed on different sides so that a welding process can be smoothly performed.

In some implementations, cathode tabs 120 and anode tabs 140 may be formed asymmetrically. For example, the number of cathode tabs 120 formed on a first side S1 and the number of anode tabs 140 formed on a second side S2 may be different from each other. In an embodiment, a position where a cathode tab 120 is formed on a first side S1 and a position where an anode tab 140 is formed on a second side S2 may be different from each other.

The number of anode tabs 140 may be greater than the number of cathode tabs 120. For example, three anode tabs 140 may be provided, including first to third anode tabs 142, 144, 146, and two cathode tabs 120 may be provided, including first and second cathode tabs 122, 124. In this case, anode tabs 140 may be connected to a smaller number of electrode plates (anode active material layers of an anode ANO) than cathode tabs 120. It is more difficult to perform a welding process on the anode than the cathode. The disclosed technology can be implemented in some embodiments to address this issue by forming a larger number of anode tabs 140 on anodes ANO than the cathode tabs on the cathodes CAT.

An arrangement structure of cathode tabs 120 on a first side S1 and an arrangement structure of anode tabs 140 on a second side S2 may be different from each other. In an embodiment, at least one of the anode tabs 140 may be formed at a position corresponding to a region in which no cathode tabs 120 are disposed. For example, at least one of anode tabs 140 (e.g., a second anode tab 144) may be formed in a central portion of a second side S2, but no cathode tab 120 may be formed in a central portion of a first side S1. Here, the term “central portion” may be used to indicate a central portion in each of first side S1 or second side S2. Therefore, at least one of anode tabs 140 may overlap with a central region of a second side S2, and cathode tabs 120 may not overlap with a central region of a first side S1.

In an embodiment, each of the cathode tabs 120 on a first side S1 may be adjacent to an edge. In an embodiment, at least one of cathode tabs 120 may be adjacent to a first edge of a first side S1, and at least one other of cathode tabs 120 may be adjacent to a second edge of a first side S1. For example, a first cathode tab 122 may be adjacent to a first edge of a first side S1, and a second cathode tab 124 may be adjacent to a second edge, which is on an opposite side of a first edge of a first side S1. In this case, a first cathode tab 122 and a second cathode tab 124 may be sufficiently spaced apart from each other. For example, a first cathode tab 122 and a second cathode tab 124 may be spaced apart by a first distance 1220. In some implementations, a first distance 1220 may be sufficiently long due to an arrangement of cathode tabs 120, and a welding process for forming cathode tabs 120 can be smoothly performed.

In an embodiment, each of anode tabs 140 on a second side S2 may be adjacent to an edge. In an embodiment, at least one of anode tabs 140 may be adjacent to a first edge of a second side S2, and at least one other of anode tabs 140 may be adjacent to a second edge of a second side S2. For example, a first anode tab 142 may be adjacent to a first edge of a first side S1, and a third anode tab 146 may be adjacent to a second edge, which is opposite to a first edge of a second side S2. In this case, a spacing distance between anode tabs 140 may be sufficiently long. For example, a second distance 1420, which is a spacing distance between a first anode tab 142 and a second anode tab 144 that are adjacent to each other, and a third distance 1440, which is a spacing distance between a third anode tab 146 and a second anode tab 144 that are adjacent to each other, may be sufficiently long, and a welding process for forming anode tabs 120 can be smoothly performed.

In some implementations, as described above, the thickness of a cathode current collector for forming a cathode CAT may be greater than the thickness of an anode current collector for forming an anode ANO. When an anode current collector comprises copper and a cathode current collector comprises aluminum, even though the thickness of an anode current collector is thinner than the thickness of a cathode current collector, it is difficult to perform a welding process for anode tabs 140 more smoothly than a welding process for cathode tabs 120.

For example, copper for forming an anode current collector may have lower ductility than aluminum for forming a cathode current collector. Therefore, when ultrasonic welding is performed in a welding process, there is a risk that an anode current collector having low ductility may be damaged by ultrasonic welding, and thus a relatively high process difficulty may be required. In addition, copper for forming an anode current collector may have a lower laser absorption rate than that of aluminum for forming a cathode current collector (e.g., copper may have a laser absorption rate that is about 4% lower than that of aluminum at room temperature.). Therefore, when laser welding is performed in a welding process, a spatter may be formed more strongly on an anode current collector, and it may be difficult to perform welding smoothly due to a formed spatter and a surface state of an anode current collector based on a spatter.

Therefore, in an embodiment, an arrangement structure and the number of anode tabs 140 and cathode tabs 120 may be optimized in consideration of asymmetrical characteristics of a welding process. For example, each of the anode tabs 140, on which a welding process is relatively difficult to perform, may be connected to a relatively small number of anodes ANO, thereby improving process efficiencies. In addition, each of the cathodes tabs 120, on which a welding process may be performed relatively smoothly, may be connected to a relatively large number of cathodes CAT so that a small number of cathode tabs 120 are formed, thereby simplifying the manufacturing process. In this way, a welding process for forming cathode tabs 120 and anode tabs 140 may be optimized for each of a first side S1 and a second side S2.

2. Manufacturing Method for Lithium Secondary Battery

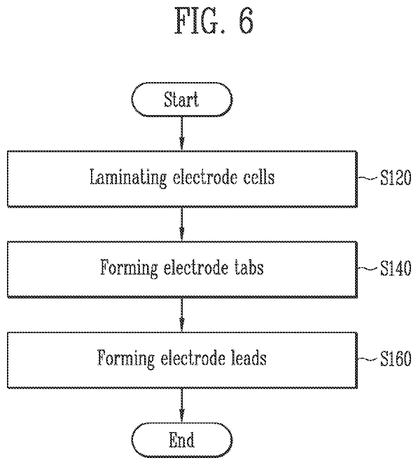

Hereinafter, a manufacturing method for lithium secondary battery SB based on an embodiment will be described with reference to FIG. 6 in addition to the previously-discussed drawings. Contents that may overlap with the contents described above are briefly explained or are not described repeatedly.

FIG. 6 is a schematic flowchart of a manufacturing method for lithium secondary battery based on an embodiment.

Referring to FIG. 6, a manufacturing method for lithium secondary battery based on an embodiment of the disclosed technology may comprise laminating electrode cells S120; forming electrode tabs S140; and forming electrode leads S160.

In laminating electrode cells S120, a plurality of electrode cells CEL in which a cathode CAT, a separator SEP, and an anode ANO are sequentially laminated may be formed. In addition, an electrode assembly AS having a stack-type structure may be formed by laminating electrode cells CEL. As described above, an electrode assembly AS based on an embodiment may have a stack-type structure so that a sufficiently high energy density can be secured.

In forming electrode tabs S140, cathode tabs 120 may be formed on a first side S1 of electrode cells CEL, but anode tabs 140 may be formed on a second side S2 of electrode cells CEL. For example, conductive lines extending from respective cathodes CAT (e.g., cathode current collector) may be welded on a first side S1 to form cathode tabs 120. Conductive lines extending from respective anodes ANO (e.g., anode current collector) may be welded on a second side S2 to form anode tabs 140.

In this step, anode tabs 140 and cathode tabs 120 may be formed to have an asymmetrical structure. For example, the number of anode tabs 140 may be greater than the number of cathode tabs 120. For example, a first cathode tab 122 and a second cathode tab 124 may be formed in each of two regions of a first side S1, and first anode tab 142, a second anode tab 144, and a third anode tab 146 may be formed in each of three regions of a second side S2. It is obvious that the number of cathode tabs 120 and anode tabs 140 may be variously changed.

In forming electrode leads S160, a cathode lead 220 for electrically connecting cathode tabs 120 with an external device and an anode lead 240 for electrically connecting anode tabs 140 with an external device may be formed.

In this step, a cathode lead 220 may electrically contact with cathode tabs 120, and an anode lead 240 may electrically contact with anode tabs 140. Since a cathode lead 220 and an anode lead 240 are formed on different sides, a connection process between electrode tabs and a cathode lead 220 and an anode lead 240 can be simplified, and process efficiencies can be improved.

In an embodiment, a structure in which a cathode lead 220 and an anode lead 240 are bonded to an electrode tab may be formed in various ways, and is not necessarily limited to a particular example. For example, any one of cathode tabs 120 may be disposed on one surface of a cathode lead 220, and another of cathode tabs 120 may be disposed on another surface of a cathode lead 220. Similarly, some of anode tabs 140 may be disposed on one surface of an anode lead 240, while some others of anode tabs 140 may be disposed on another surface of an anode lead 240.

An electrode assembly AS implemented based on some embodiments discussed above may be provided in an exterior member HOU, and a formation process may be performed to form a lithium secondary battery SB based on an embodiment.

As described above, since a welding process is performed asymmetrically on a first side S1 where a cathode tab 120 is formed and on a second side S2 where an anode tab 140 is formed, process efficiencies can be improved, and electrode cells CEL have a stack-type structure so that a lithium secondary battery SB based on an embodiment can have high cell performance.

The disclosed technology can be implemented in rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery used in various power sources and power supplies, thereby mitigating climate changes in connection with uses of power sources and power supplies. Lithium secondary batteries based on the disclosed technology can be used to address various adverse effects such as air pollution and greenhouse emissions by powering electric vehicles (EVs) as alternatives to vehicles using fossil fuel-based engines and by providing battery-based energy storage systems (ESSs) to store renewable energy such as solar power and wind power.

Only specific examples of implementations of certain embodiments are described. Variations, improvements and enhancements of the disclosed embodiments and other embodiments may be made based on the disclosure of this patent document.

What is claimed is:

1. A lithium secondary battery comprising:
an exterior member;
electrode cells disposed within the exterior member, each electrode cell including a cathode, an anode, and a separator disposed between the cathode and the anode;
cathode tabs disposed on a first side of the cathode and configured to electrically connect conductive lines extending from the cathodes in the electrode cells; and
anode tabs disposed on a second side of the anode that is different from the first side of the cathode, and configured to electrically connect conductive lines extending from the anodes in the electrode cells,
wherein the cathode tabs and the anode tabs are formed asymmetrically on different sides.

2. The lithium secondary battery according to claim 1, further comprising a cathode lead that is electrically connected to the cathode through the cathode tabs; and
an anode lead that is electrically connected to the anode through the anode tabs,
wherein the second side of the anode is an opposite side of the first side of the cathode.

3. The lithium secondary battery according to claim 1, wherein a number of the anode tabs is greater than a number of the cathode tabs.

4. The lithium secondary battery according to claim 3, wherein the cathode comprises a cathode current collector and a cathode active material layer disposed on the cathode current collector and including a cathode active material that allows lithium ions to be inserted to and extracted from the cathode active material layer,
wherein the anode comprises an anode current collector and an anode active material layer on the anode current collector and including an anode active material that allows lithium ions to be inserted to and extracted from the anode active material layer, and
wherein a thickness of the anode current collector is thinner than a thickness of the cathode current collector.

5. The lithium secondary battery according to claim 4, wherein the anode current collector comprises copper, and
wherein the cathode current collector comprises aluminum.

6. The lithium secondary battery according to claim 1, wherein at least one of the cathode tabs is disposed adjacent to a first edge of the first side of the cathode, and at least one other of the cathode tabs is disposed adjacent to a second edge of the first side of the cathode, and
wherein at least one of the anode tabs is disposed adjacent to the first edge of the second side of the anode, and at least one other of the anode tabs is disposed adjacent to the second edge of the second side of the anode.

7. The lithium secondary battery according to claim 6, wherein at least one of the anode tabs is disposed in a central portion of the second side of the anode, and
wherein the cathode tabs are not be disposed in a central portion of the first side of the cathode.

8. The lithium secondary battery according to claim 1, wherein the electrode cells have a stack-type structure.

9. The lithium secondary battery according to claim 1, wherein the exterior member is structured to form an enclosure in which electrode cells are placed.

10. The lithium secondary battery according to claim 1, wherein the exterior member is a pouch type enclosure.

11. A manufacturing method for lithium secondary battery, comprising:
laminating electrode cells, each electrode cell including a cathode, an anode, and a separator disposed between the cathode and the anode;
forming electrode tabs; and
forming electrode leads,
wherein the forming the electrode tabs comprises:
forming, on first sides of cathodes of the electrode cells, cathode tabs configured to electrically connect conductive lines extending from the cathodes of the electrode cells; and
forming, on second sides of anodes of the electrode cells that are different from the first sides of the cathodes, anode tabs configured to electrically connect conductive lines extending from the anodes of the electrode cells, and
wherein the cathode tabs and the anode tabs are formed asymmetrically on different sides.

12. The manufacturing method for lithium secondary battery according to claim 11, wherein a number of the anode tabs is greater than a number of the cathode tabs.

13. The manufacturing method for lithium secondary battery according to claim 11, wherein each of the cathodes comprises a cathode current collector and a cathode active material layer disposed on the cathode current collector,
wherein each of the anodes comprises an anode current collector and an anode active material layer on the anode current collector, and
wherein a thickness of the anode current collector is thinner than a thickness of the cathode current collector.

14. The manufacturing method for lithium secondary battery according to claim 11, wherein the forming the electrode tabs further comprises performing a welding process for forming the cathode tabs and the anode tabs.
